(19) United States
(12) Patent Application Publication
(10) Pub. No.: US 2013/0167003 A1
(43) Pub. Date: Jun. 27, 2013

(54) ALERT AND NOTIFICATION DEFINITION USING CURRENT REPORTING CONTEXT

(71) Applicants: Stefan Mueller, Sinsheim (DE); Dominic Schmoigl, Mannheim (DE)

(72) Inventors: Stefan Mueller, Sinsheim (DE); Dominic Schmoigl, Mannheim (DE)

(21) Appl. No.: 13/335,818

(22) Filed: Dec. 22, 2011

(51) Int. Cl. G06F 17/00; G08B 21/00

(52) U.S. Cl. 715/221; 340/540

(57) ABSTRACT

Methods and apparatus, including computer program products, are provided for alerts on fields of a report. In one aspect, there is provided a computer-implemented method. The method may receiving, at a first processor, a report generated at a second processor; determining, at the first processor, whether an alert defined for the received report is triggered; and providing an indication that the alert is triggered based on the determining. Related systems, methods, and articles of manufacture may also be provided.

### FIELD

The present disclosure generally relates to data processing and, in particular, alerts.

### BACKGROUND

Business systems, such as enterprise resource planning systems, may be configured to integrate management information from across an entity, or enterprise. Indeed, such management information may include information representative of sales, accounting, customer relationship management, finance, service, manufacturing, and the like. This management information may include data (also referred to a performance data, key performance information, and/or key figures data) which allows users to make decisions and manage the enterprise. Moreover, this data may be provided to users in the form of reports. However, users are often inundated in data and reports, making decision-making difficult to say the least.

### SUMMARY

In one aspect there is provided a method. The method may include receiving, at a first processor, a report generated at a second processor; determining, at the first processor, whether an alert defined for the received report is triggered; and providing an indication that the alert is triggered based on the determining.

In some implementations, the above-noted aspects may further include additional features described herein including one or more of the following. A user interface may be used to define the alert by at least selecting a field of the report. A user interface may be used to define the alert by at least selecting a column of the report. Information may be received from the user interface, and the received information may be representative of the alert linked to at least one field of the report, wherein the alert is triggered when a data value in the at least one field satisfies a trigger value. A determination may be made of whether the at least one field in the received report includes a data value which triggers the alert defined for the at least one field. The received report may include at least one of a plurality of alerts defined for at least one of a plurality of fields in the received report.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

In the drawings,

FIG. 1 depicts an alert notification system;

FIG. 2 depicts a page including a report;

FIG. 3 depicts a page including information defining an alert on a field of a report;

FIG. 4A depicts another example of a report and an alert definition page;

FIG. 4B depicts the alert definition page of FIG. 4A;

FIG. 4C depicts a process for defining an alert for a report; and

FIGS. 5-7 depict an example implementation of the system of FIG. 1 as an enterprise resource planning system.

Like labels are used to refer to same or similar items in the drawings.

### DETAILED DESCRIPTION

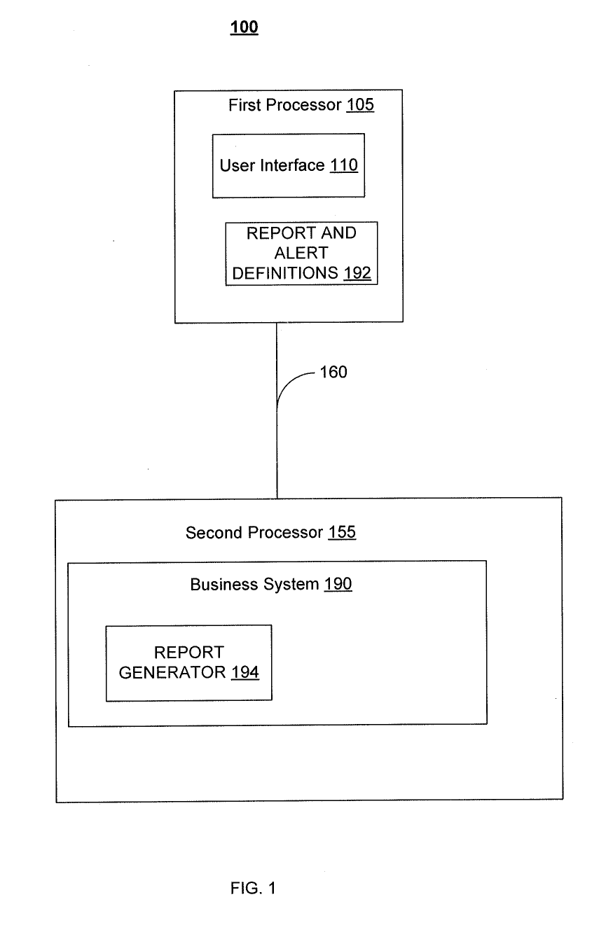

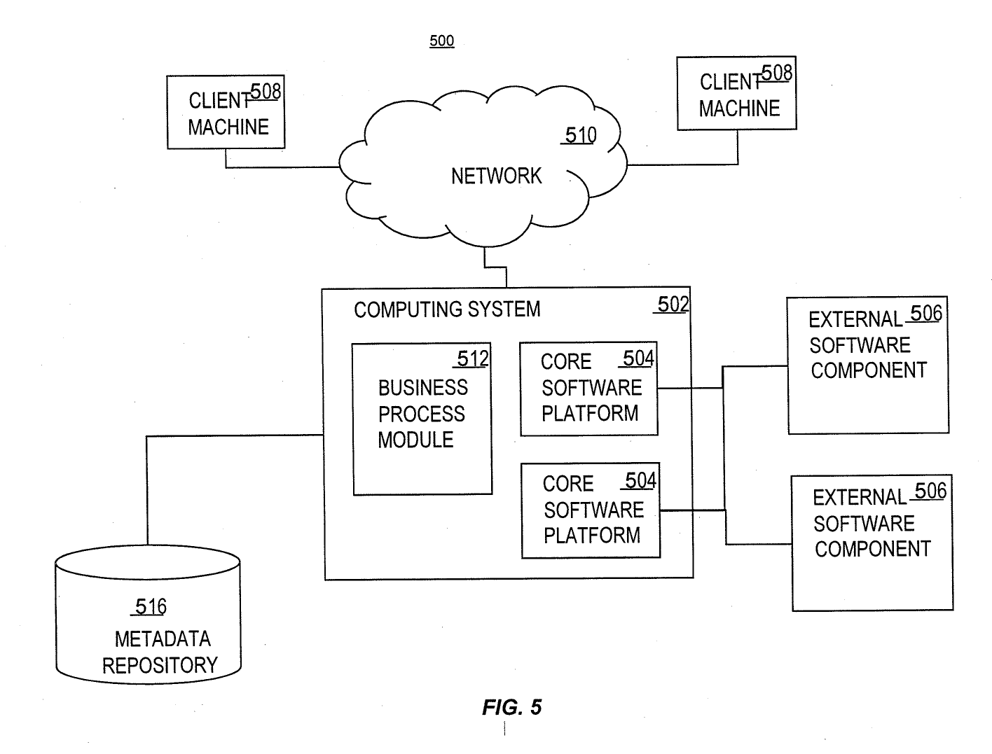

FIG. 1 depicts a system 100 including a first processor 105 coupled via a network 160 to a second processor 155, which further includes a business system 190, such an enterprise resource planning system (which is further described below with respect to FIGS. 5-7), a sales force management system, a personnel management system, and/or any other type of enterprise business system.

The business system 190 includes a report generator 194 configured to generate reports on key performance information being managed by business system 190, and configured to send the generated reports to first processor 105 for presentation at user interface 110. The subject matter disclosed herein relates to the report and alert definitions module 192 defining alerts on the reports themselves, so that when the criteria of the defined alert is satisfied, the alert is triggered at the first processor 105 and/or user interface 110.

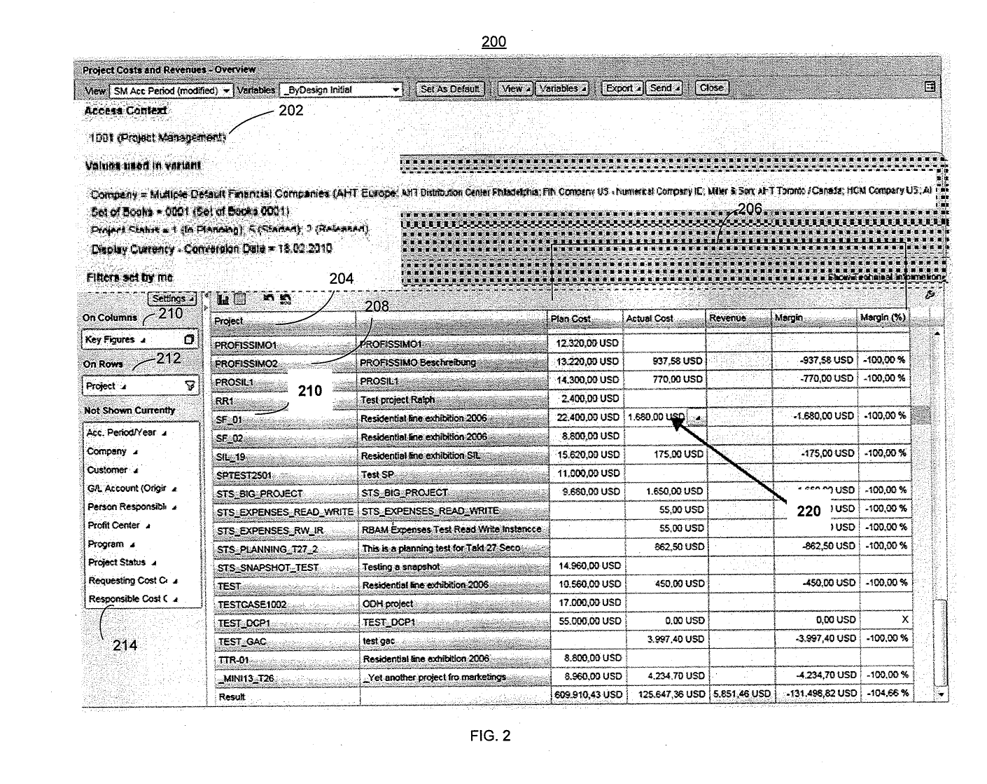

FIG. 2 depicts a page 200 including an example of a report generated by report generator 194 and presented at user interface 110. The page 200 corresponds to the business system 190, which in this example is a project management 202 system tracking a plurality of projects. As such, a plurality of projects 204 are shown in the first column of the report and each row has data 206 (e.g., key figures) for the projects. For example, project “PROFISSIMO2” 208 has a plan cost of $13,220.00, an actual cost of $937.58, and a margin of −$947.58. The configuration of page 200 may be modified in various ways. For example, the contents of the columns may be configured at 210, and the content of the rows may be configured at 212. Page 200 also allows configuration, at 214, of the data 206 presented by the report.

A key figure, such as actual cost, may be selected to be monitored by an alert defined and stored at report and alert definitions module 192. The alert may be defined for all projects, in which case the column for actual cost may be selected (e.g., by selecting a column or a down box displaying columns), or may be defined for a specific project by selecting a particular field of a given project. For example, a user may select, at 220, the actual cost field for project “SF_{—}01” 210. Next, the user may configure (e.g., define) the alert selected at 220.

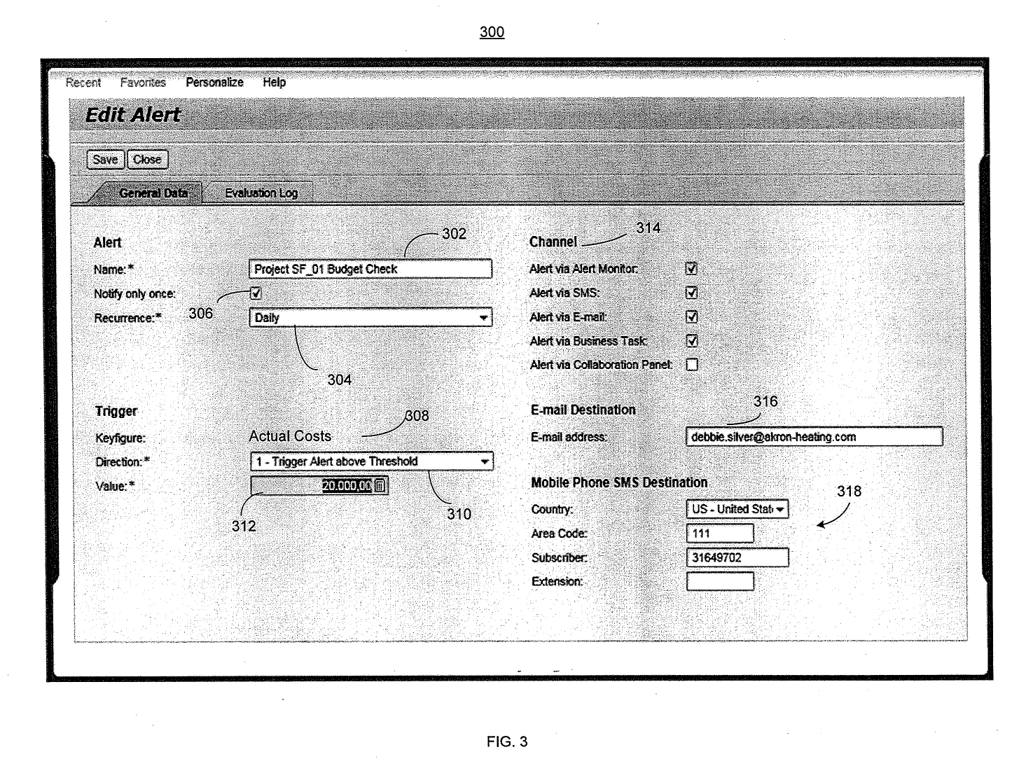

FIG. 3 depicts a page 300 where the configuration of an alert may be provided and/or defined. Specifically, when the user selects an aspect of the report for alerting, page 300 is generated by the report and alert definitions module 192 and then presented at user interface 110.

At 302, page 300 allows an alert to be named for the selected field. For example, the alert 302 is named “Project SF_{—}01 Budget Check.” Once named, report and alert definitions module 192 stores alert metadata associated with the alert. This alert metadata includes context information allowing the alert to navigate through a report and determine whether a value in the report satisfies a trigger, and, if so, sending an alert in accordance with the defined alert. For example, the metadata (or context information) may define the report (e.g., a unique identifier for the report at page 200), define the structure of the report, identify the location (e.g., row and column) of the selected field 220 in the report, and include any other data to define the alert. This alert metadata provides the context of the report, so that the defined alert (which is stored at report and alert definitions 192) can process reports received at the first processor 105 and can determine whether to trigger the defined alert. For example, each time a report is received at first processor 105, the defined alert may calculate the key figure value associated with the field linked to the alert and determine whether the field has triggered the alert.

Page 300 may also enable definition of the frequency of the alert 306 and whether the alert is a one-time alert 304. The trigger for the alert may also be defined. In the example of page 300, the trigger corresponds to “Actual Costs” 308, which defines the row and column in the report selected for monitoring and alerting at page 300. The trigger for the alert may be defined as a threshold. For example, at 310, the trigger is defined such that if the field 220 (FIG. 2) is above 310 a threshold value provided at 312 (which in the example is 20,000), an alert is triggered by report and alert definitions module 192.

Page 300 also allows defining how the triggered alert will be delivered. For example, the alert may be delivered by any kind of alert monitor application, a short message service message, an email, a task, a panel, and the like. Page 300 also allows defining an email 316 for delivery of alerts and a phone number 318, where SMS messages may be delivered with the alerts. Once the trigger is defined at page 300 and stored by report and alert definitions module 192, the report and alert definitions module 192 may be invoked, or executed, by first processor 105 to monitor reports received from second processor 155 to see if the trigger for the defined alert is satisfied, in which case the alert is triggered (e.g., sent).

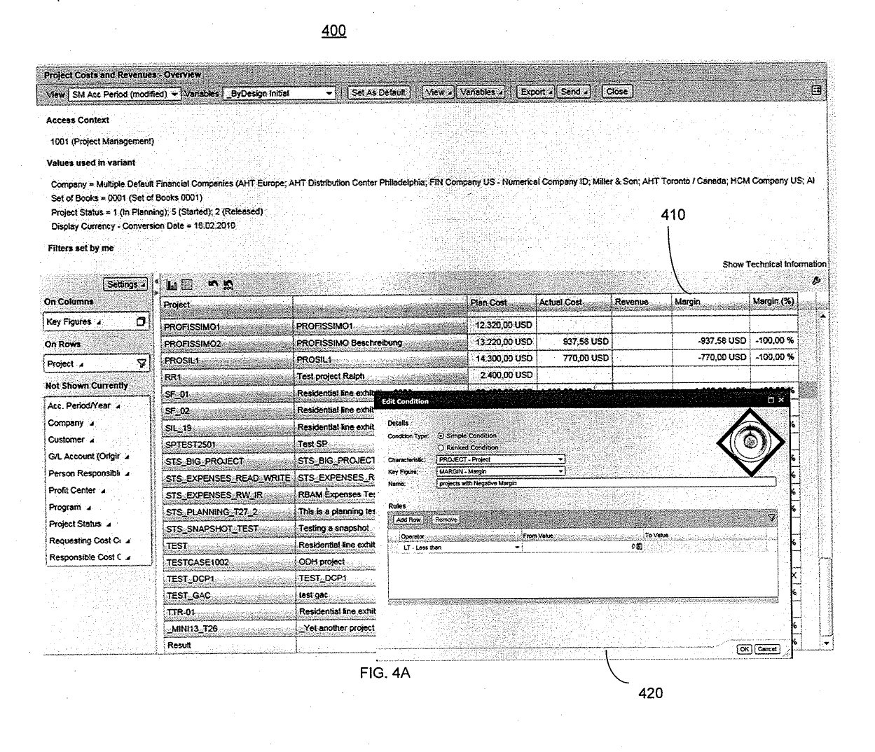

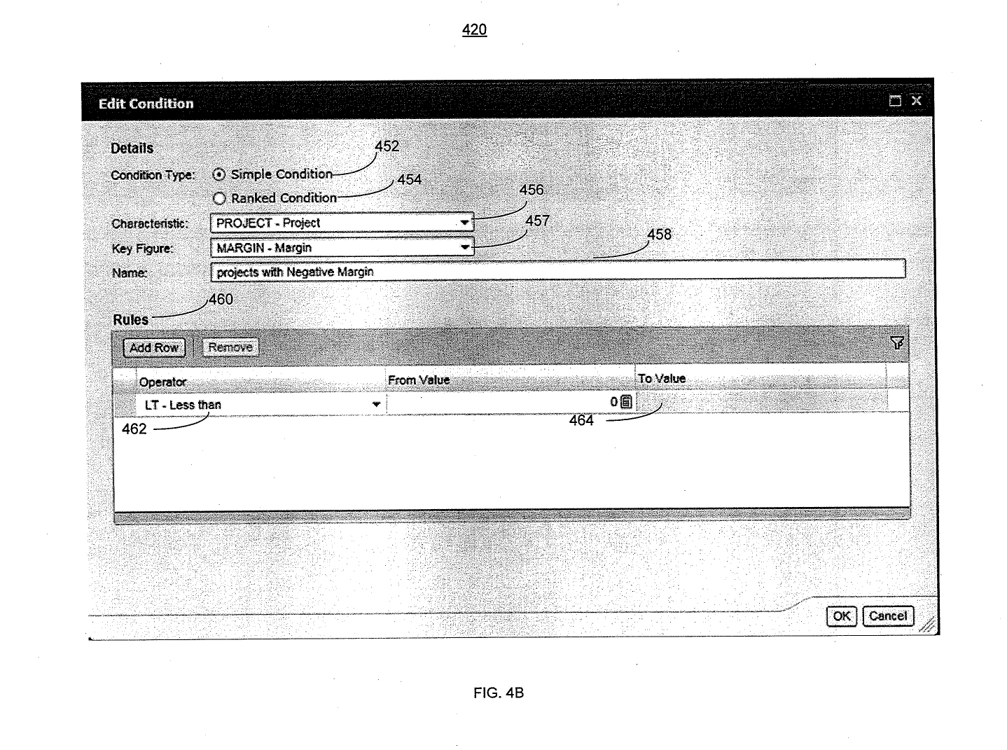

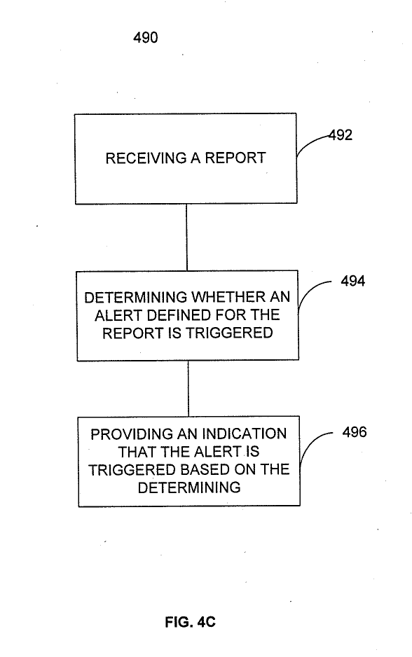

FIG. 4A depicts a page 400 of a report generated by report generator 194 and presented at user interface 110. Page 400 is similar to page 300 but shows an alert being defined for the key figure column named margin 410. Once column margin 410 is selected, report and alert definitions module 192 generates an alert definition page 420.

FIG. 4B depicts an example implementation of alert definition page 420, where the alert can be defined. Page 420 is similar to page 300 in some respects, but page 420 is configured to define an alert for a plurality of fields (e.g., a column) of a report, rather than a single field (such as field 220, the alert of which is defined at 300). As such, a set of key figure values may be specified for an alert to satisfy the trigger condition. For example, at page 420, a user may want to be informed as soon as any project's margin falls below a threshold provided/defined at page 420 (e.g., a negative margin).

Page 420 defines the alert by enabling configuration of whether the condition is simple 452 or ranked 454. Page 420 also enables defining characteristics 456, the key figure column 457 being monitored by the alert defined at page 420, and a name 458 for the alert defined at page 420. The alert being defined at 420 also includes one or more rules 460 for processing the data in the key figure column 456 of the report being monitored. In the example of page 420, if the margin column 457 is less than 462 a threshold value 464 (which in this example is zero) the alert is triggered.

FIG. 4C depicts a process 490 for processing reports based on alerts defined for the report.

At 492, a report is received. For example, first processor 105 may receive a report from second processor 155. The received report may be generated by report generator 194 and correspond to data representative of business system 190. Moreover, an alert may be defined for the report as described above and executed at first processor 105.

At 494, a determination may be made regarding whether that received report triggers an alert. In some implementations, report and alert definitions 192 may determine whether any of the alerts have been triggered by the received report. For example, report and alert definitions 192 may execute the alert on the received report. Because the report is self-defining in the sense that the alert understands how to navigate through the received report to a field(s) linked to the alert, the report is able to determine whether the trigger (which is also defined in the alert) has been triggered by the received report. Referring to the example of FIGS. 2 and 3, the alert would navigate through the received report defined at FIG. 3, read the data in the report corresponding to the selected field (e.g., “Actual Cost” for project “SF_{—}01”), and trigger when the selected field, “Actual Cost” for project “SF_{—}01,” exceeds $20,000. The alert defined at FIG. 4B would also be applied against the received report as well to determine whether the trigger is satisfied.

At 496, an indication is provided indicating that the alert is triggered based on the results of 494. In some implementations, report and alert definitions 192 may determine whether any alerts have been triggered by the received report, at 494, and, if so, an indication, such as an SMS message, email, and the like may be sent. Moreover, the indication itself may be defined as noted at FIGS. 3 at 314, 316, and 318. Referring to the example of FIGS. 2 and 3, when the alert defined at FIG. 3 is triggered (e.g., with an Actual Cost exceeding $20,000), an indication of the alert is sent in accordance with the alert definition. For example, the indication would be sent only once 306, daily 304, via channels 314 (e.g., Alert Monitor, SMS, email, and business task), to the email address debbie.silver@akron-heating.com 316 and as SMS to the given phone number 318.

System 100 may thus allow a user to define an alert, such that the defined alert includes metadata (also referred to as context) defining the report and how to navigate to the field(s) being monitored by the alert. Once the alert is defined, the alert including context/metadata is executed by the alert and notification definition module 192 to monitor reports received from business system 190. The defined alert allows determining whether the values in the report trigger the alert, and if so, an alert message is sent.

The following describes an example implementation of system 100 in an enterprise resource planning system (ERP) framework. In some implementations, system 100 may be implemented as a core software platform of an ERP software architecture, which can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible.

FIG. 5 shows a diagram of a system 500 consistent with such an implementation. The business system 190 of FIG. 1 may be implemented in accordance with system 500. A computing system 502 can include one or more core software platform modules 504 providing one or more features of the ERP system. The computing system can also aggregate or otherwise provide a gateway via which users can access functionality provided by one or more external software components 506, which can optionally be provided by one or more service providers external to the one or more core software platform modules 504. Client machines 508 may include user interfaces, such as user interface 110, and can access the computing system, via a direct connection, a local terminal, or over a network 510 (e.g. a local area network, a wide area network, a wireless network, the Internet, or the like). A business scenario guidance and recording module 512 can be hosted on the computing system 502 or alternatively, on an external system accessible over a network connection. The business scenario guidance and recording module 512 can optionally include one or more discrete software and/or hardware modules that perform operations such as those described herein.

The business scenario guidance and recording module 512 can access one or more metadata repositories 516 and/or other data repositories that can store the definition of business process as well as data relating to concrete instances of the data objects (e.g. business objects) that are relevant to a specific instance of the business process. In some examples, the definition can optionally be stored as a business object. In some implementations, the business object can include a template definition of a standard business process. The template definition that can optionally be modified via one or more extensions that are stored in the one or more metadata repositories 516.

Smaller organizations can also benefit from use of ERP functionality. However, such an organization may lack the necessary hardware resources, IT support, and/or consulting budget necessary to make use of a standalone ERP software architecture product and can in some cases be more effectively served by a software as a service (SaaS) arrangement in which the ERP system architecture is hosted on computing hardware such as servers and data repositories that are maintained remotely from the organization's location and accessed by authorized users at the organization via a thin client, such as for example a web browser, over a network.

In a software delivery configuration in which services of an ERP system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

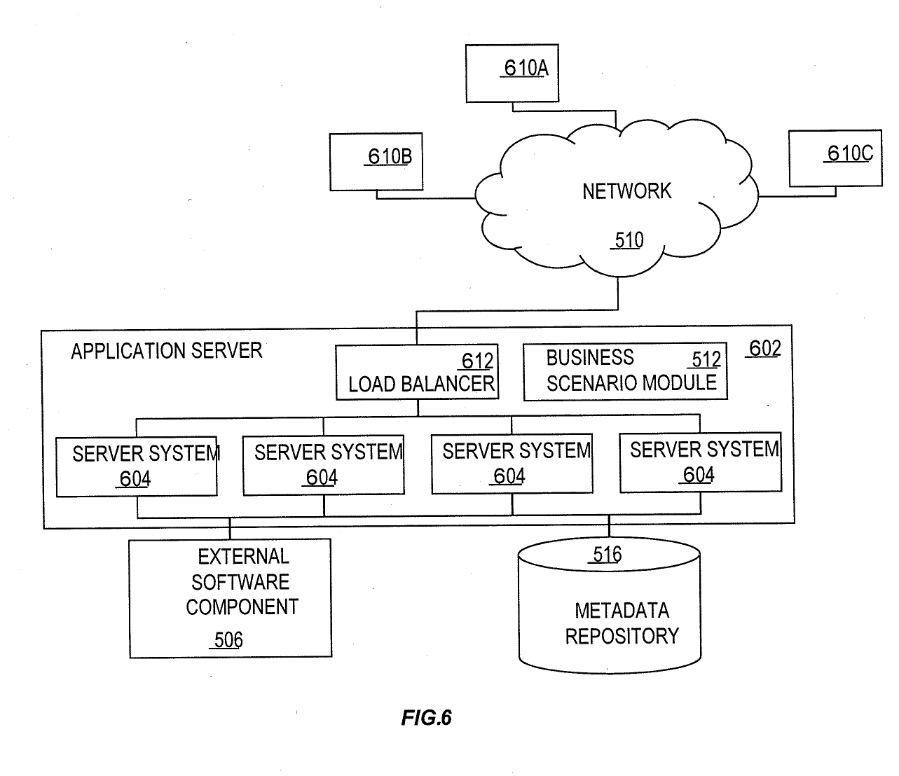

FIG. 6 shows a block diagram of a multi-tenant implementation of a software delivery architecture 600 that includes an application server 602, which can in some implementations include multiple server systems 604 that are accessible over a network 606 from client machines operated by users at each of multiple organizations 610A-610C (referred to herein as “tenants” of a multi-tenant system) supported by a single software delivery architecture 600. For a system in which the application server 602 includes multiple server systems 604, the application server can include a load balancer 612 to distribute requests and actions from users at the one or more organizations 610A-610C to the one or more server systems 604. Instances of the core software platform 604 (not shown in FIG. 6) can be executed in a distributed manner across the server systems 604. A user can access the software delivery architecture across the network using a thin client, such as for example a web browser or the like or other portal software running on a client machine. The application server 602 can access data and data objects stored in one or more data repositories 616. The application server 602 can also serve as a middleware component via which access is provided to one or more external software components 606 that can be provided by third party developers.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 602 that includes multiple server systems 604 that handle processing loads distributed by a load balancer 612. Potential benefits from such an arrangement can include, but are not limited to, high and reliably continuous application server availability and minimization of unplanned downtime, phased updating of the multiple server systems 604 to permit continuous availability (one server system 604 can be taken offline while the other systems continue to provide services via the load balancer 612), scalability via addition or removal of a server system 604 that is accessed via the load balancer 612, and de-coupled lifecycle processes (such as for example system maintenance, software upgrades, etc.) that enable updating of the core software independently of tenant-specific customizations implemented by individual tenants.

As in the example illustrated in FIG. 6, the metadata repository 616 can store a business object that represents a template definition of a standard business process. Each individual tenant 610A-610C can customize that standard template according to the individual business process features specific to business of the organization to which that tenant is assigned. Customizations can be stored as extensions in the metadata repository.

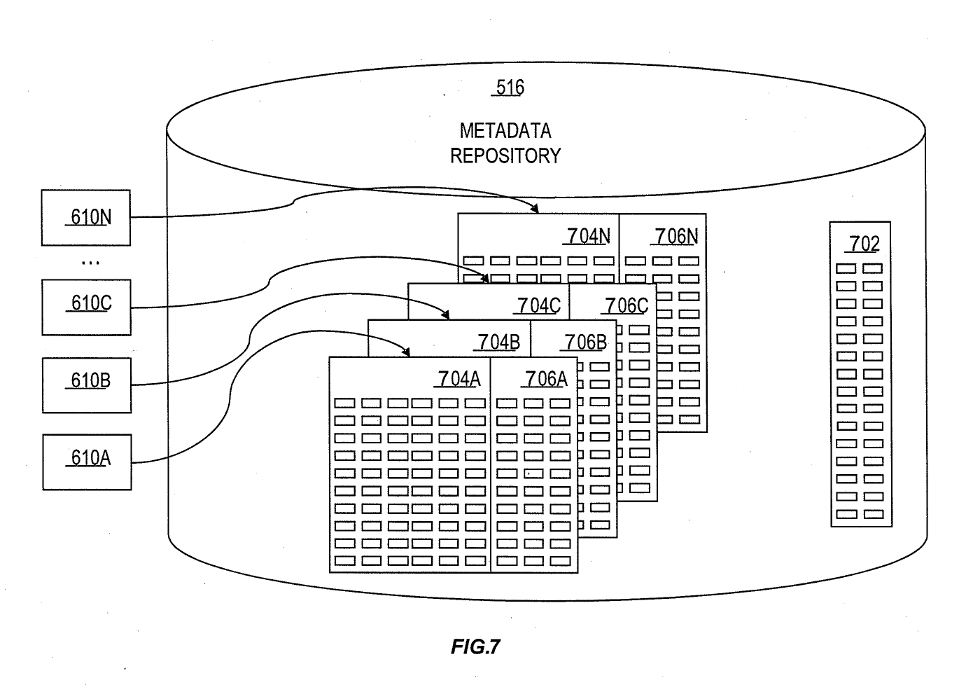

To provide for customization of the business scenarios and/or business processes for each of multiple organizations supported by a single software delivery architecture 600, the data and data objects stored in the metadata repository 616 and/or other data repositories that are accessed by the application server 602 can include three types of content as shown in FIG. 7: core software platform content 702 (e.g. a standard definition of a business process), system content 704, and tenant content 706. Core software platform content 702 includes content that represents core functionality and is not modifiable by a tenant. System content 704 can in some examples be created by the runtime of the core software platform and can include core data objects that store concrete data associated with specific instances of a given business process and that are modifiable with data provided by each tenant. The data retained in these data objects are tenant-specific: for example, each tenant 610A-610N can store information about its own inventory, sales order, etc. Tenant content 706A-706N includes data objects or extensions to other data objects that are customized for one specific tenant 610A-610N to reflect business processes and data that are specific to that specific tenant and are accessible only to authorized users at the corresponding tenant. Such data objects can include a key field (for example “client” in the case of inventory tracking) as well as one or more of master data, business configuration information, transaction data, or the like. For example, tenant content 706 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 702 and system content 704 and tenant content 706 of a specific tenant are accessed to provide the business process definition and/or the status information relating to a specific instance of the business process according to customizations and business data of that tenant such that each tenant is provided access to a customized solution whose data are available only to users from that tenant. The report generator 194 may thus generate reports for the ERP system noted above enabling the end user to aggregate data based on his/her business needs.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. For example, while the descriptions of specific implementations of the current subject matter discuss analytic applications, the current subject matter is applicable to other types of software and data services access as well. Moreover, although the above description refers to specific products, other products may be used as well. In addition, the logic flows depicted in the accompanying figures and described herein do not require the particular order shown, or sequential order, to achieve desirable results. Other embodiments may be within the scope of the following claims.

1. A non-transitory computer-readable medium containing instructions to configure at least one processor to cause operations comprising:
receiving, at a first processor including a user interface, a report generated at a second processor;
defining, at the user interface including the report, the alert by at least selecting at least one of a field of the report or a column of the report;
determining, at the first processor, whether an alert defined for the received report is triggered, wherein the alert includes a condition and metadata, wherein the condition is representative of a trigger for the alert, and wherein the metadata defines navigation through the report to determine whether the selected at least one of the field or the column satisfy the condition; and
providing an indication that the alert is triggered based on the determining.

2-3. (canceled)

4. The non-transitory computer-readable medium of claim 1, further comprising:
receiving, from a user interface, information representative of the alert linked to at least one field of the report, wherein the alert is triggered when a data value in the at least one field satisfies a trigger value.

5. The non-transitory computer-readable medium of claim 1, wherein determining further comprises:
determining whether the at least one field in the received report includes a data value which triggers the alert defined for the at least one field.

6. The non-transitory computer-readable medium of claim 1, wherein the received report includes at least one of a plurality of alerts defined for at least one of a plurality of fields in the received report.

7. A method comprising:
receiving, at a first processor including a user interface, a report generated at a second processor;
defining, at the user interface including the resort the alert b at least selectins at least one of a field of the report or a column of the report;
determining, at the first processor, whether an alert defined for the received report is triggered, wherein the alert includes a condition and metadata, wherein the condition is representative of a trigger for the alert, and wherein the metadata defines navigation through the report to determine whether the selected at least one of the field or the column satisfy the condition; and
providing an indication that the alert is triggered based on the determining.

8-9. (canceled)

10. The method of claim 7, further comprising:
receiving, from a user interface, information representative of the alert linked to at least one field of the report, wherein the alert is triggered when a data value in the at least one field satisfies a trigger value.

11. The method of claim 7, wherein determining further comprises:
determining whether the at least one field in the received report includes a data value which triggers the alert defined for the at least one field.

12. The method of claim 7, wherein the received report includes at least one of a plurality of alerts defined for at least one of a plurality of fields in the received report.

13. A system comprising:
at least one processor; and
at least one memory, which when executed by the at least one processor causes operations comprising:
defining, at the user interface including the report, the alert b at least selecting at least one of a field of the report or a column of the report;
determining, at the first processor, whether an alert defined for the received report is triggered, wherein the alert includes a condition and metadata, wherein the condition is representative of a trigger for the alert, and wherein the metadata defines navigation through the report to determine whether the selected at least one of the field or the column satisfy the condition; and
providing an indication that the alert is triggered based on the determining.

14-15. (canceled)

16. The system of claim 13, further comprising:
receiving, from a user interface, information representative of the alert linked to at least one field of the report, wherein the alert is triggered when a data value in the at least one field satisfies a trigger value.

17. The system of claim 13, wherein determining further comprises:
determining whether the at least one field in the received report includes a data value which triggers the alert defined for the at least one field.

18. The system of claim 13, wherein the received report includes at least one of a plurality of alerts defined for at least one of a plurality of fields in the received report.
